(19) United States
(12) Patent Application Publication
(10) Pub. No.: US 2010/0049447 A1
(43) Pub. Date: Feb. 25, 2010

(54) Method of modeling the behavior of an eye subjected to an external force

(76) Inventors: Gholam Peyman, Sun City, AZ (US); Eniko Todorov Enikov, Tuscon, AZ (US)

Correspondence Address: Francis Law Group, 1942 Emabarcadero, Oakland, CA, 94606, US

(21) Appl. No.: 12/583,466

(22) Filed: Aug. 21, 2009

Related U.S. Application Data
(60) Provisional application No. 61/189,725, filed on Aug. 22, 2008.

(51) Int. Cl. G06F 19/00; G06G 7/48; G01M 19/00

(52) U.S. Cl. 702/19; 703/11; 73/866.4

(57) ABSTRACT

A method for simulating the behavior of an eye comprising the steps of (i) generating a FEM model of the eye representing the physical structure of the eye, the FEM model including an elastic walled corneo-scleral shell, (ii) modeling deformations of the eye with the FEM model, the deformation modeling including the simulated application of at least one external force to the FEM model, and (iv) obtaining FEM model solutions iteratively in an incremental fashion, whereby adjustable nodal pressure is introduced inside the corneo-scleral shell.

### CROSS-REFERENCE TO RELATED APPLICATIONS

This application claims the benefit of U.S. Provisional Application No. 61/189,725, filed Aug. 22, 2008.

### FIELD OF THE PRESENT INVENTION

The present invention relates generally to anatomical models. More particularly, the invention relates to methods of modeling the mechanical behavior of an eye that is subjected to an external force.

### BACKGROUND OF THE INVENTION

As is well known in the art of ophthalmology, measuring the intraocular pressure (IOP) of the eye is an important indicator of the health of the eye. Elevated IOP has been associated with progressive damage of the optic nerve known as glaucoma, which, if left untreated, leads to permanent loss of sight.

Various apparatus and techniques have thus been developed to measure IOP. Among the techniques are applanation tonometery, dynamic contour tonometry, transpalpebral diatom tonometry, non-contact tonometry, electronic indentation tonometry, rebound tonometry and digital palpation tonometry.

Applanation tonometry measures approximate intraocular pressure either by the force required to flatten a constant area of the cornea (e.g. Goldmann tonometry) or by the area flattened by a constant force.

In applanation tonometry, a special calibrated disinfected probe attached to a slit lamp biomicroscope is used to flatten the central cornea a fixed amount. Because the probe makes contact with the cornea, a topical anesthetic, such as oxybuprocaine, tetracaine, alcaine, proxymetacaine or proparacaine, is introduced onto the surface of the eye in the form of one or a few eye drops. A yellow fluorescein dye is often also used in conjunction with a cobalt blue filter to aid the examiner in determining the IOP.

Goldmann tonometry is considered to be the gold standard in tonometry, as it is the most widely accepted method of determining “approximate” intraocular pressure. However, as is well known in the art, Goldmann tonometry is an inherently imprecise measurement.

Dynamic contour tonometry (DCT) is a measuring technique that employs the principle of contour matching instead of applanation to eliminate the systematic errors inherent in previous tonometers. These factors include the influence of corneal thickness, rigidity, curvature and elastic properties. DCT is not influenced by mechanical changes, such as those seen in refractive surgery that would otherwise cause error in applanation tonometers.

An exemplar apparatus that employs DCT to measure IOP is the PASCAL Dynamic Contour Tonometer (Ziemer Ophthalmics). The PASCAL uses a miniature pressure sensor embedded within a tonometer tip that is contour-matched to the shape of the cornea. When the sensor is subjected to a change in pressure, the electrical resistance is altered and the PASCAL's computer calculates a change in pressure in accordance with the change in resistance.

The tonometer tip rests on the cornea with a constant appositional force of one gram. This is an important difference from all forms of applanation tonometry wherein the probe force is variable.

In transpalpebral diaton tonometry, a diaton tonometer is employed to measure intraocular pressure through the eyelid. It is typically regarded as a simple and safe method of ophthalmotonometry. Transpalpebral tonometry requires no contact with the cornea, therefore sterilization of the device and topical anesthetic drops are not required.

Non-contact tonometry or air-puff tonometry uses a rapid air pulse to applanate the cornea. Corneal applanation is detected via an electro-optical system. Intraocular pressure is estimated by detecting the force of the air jet at the instance of applanation.

Modern-day non-contact tonometers have been shown to correlate very well with Goldmann tonomtery measurements and have thus generally been considered a fast and simple way to screen for high IOP. Further, since non-contact tonometry is accomplished without the instrument contacting the cornea the potential for disease transmission is reduced.

Electronic indentation tonometry employs a Tono-Pen, i.e. a portable electronic, digital pen-like instrument that determines IOP by making contact with the cornea. Electronic indentation tonometry is especially useful for very young children, patients unable to reach a slit lamp due to disability, patients who are uncooperative during applanation tonometry, or patients with cornea disease in whom contact tonometry cannot be accurately performed.

In palpation tonometry, also known as digital palpation tonometry, measuring intraocular pressure is performed by gently pressing the fingertips of both index fingers onto the upper part of the bulbus through the eyelid. This technique requires medical experience and results in an estimation of the level of intraocular pressure based on the skills of the ophthalmologist. Digital palpation tonometry is completely analgesic and requires no anesthesia.

A major drawback associated with each of the noted techniques is that each technique requires application of an external force to the cornea or sclera.

It would thus be desirable to provide a model of the eye that accurately reflects the mechanical behavior of the eye when subjected to an external force.

It is therefore an object of the present invention to provide a model of the eye (and method for formulating same) that accurately reflects the mechanical behavior of the eye when subjected to an external force, such as during digital palpation tonometry.

It is another object of the present invention to provide a model of the eye that can be used to predict the IOP of an eye.

### SUMMARY OF THE INVENTION

In accordance with the above objects and those that will be mentioned and will become apparent below, the method for simulating the behavior of an eye, in accordance with this invention, generally comprises the following steps: (i) generating a FEM model of the eye representing the physical structure of the eye, the FEM model including an elastic walled corneo-scleral shell, (ii) modeling deformations of the eye with the FEM model, the deformation modeling including the simulated application of at least one external force to the FEM model, and (iv) obtaining FEM model solutions iteratively in an incremental fashion, whereby adjustable nodal pressure is introduced inside the corneo-scleral shell.

In another embodiment of the invention, the method for simulating the behavior of an eye comprises the following steps: (i) generating a structural model of the eye, the structural model comprising an incompressible fluid-filled elastic walled corneo-scleral shell, (ii) generating a mesh model of the eye based on the structural model, the mesh model including a plurality of nodes, (iii) modeling deformations of the eye with a finite element program (FEM), the deformation modeling including the simulated application of at least one external force to the mesh model, and (iv) obtaining model solutions of the FEM corresponding to predetermined boundary conditions iteratively in an incremental fashion, whereby adjustable nodal pressure is introduced inside the corneo-scleral shell.

In another embodiment of the invention, the method for simulating the behavior of an eye comprises the following steps: (i) generating a structural model of the eye, the structural model comprising an incompressible fluid-filled elastic walled corneo-scleral shell, (ii) generating a mesh model of the eye based on the structural model, the mesh model including a plurality of nodes, (iii) providing stress-strain characteristics for substructures associated with the eye, the substructures including a stroma, limbus, sclera and Descemet's membrane, (iv) determining a relationship between pressure and volume inside the corneo-scleral shell, (v) modeling deformations of the eye with a finite element program (FEM) as a function of the substructure stress-strain characteristics and the determined pressure and volume relationship, the deformation modeling including the simulated application of at least one external force to the mesh model, and (vi) obtaining model solutions of the FEM corresponding to predetermined boundary conditions iteratively in an incremental fashion, whereby adjustable nodal pressure is introduced inside the corneo-scleral shell.

In another embodiment of the invention, there is provided a method for determining intraocular pressure (IOP) of an eye, comprising the following steps: (i) generating a structural model of the eye, the structural model comprising an incompressible fluid-filled elastic walled corneo-scleral shell, (ii) generating a mesh model of the eye based on the structural model, the mesh model including a plurality of nodes, (iii) modeling deformations of the eye with a finite element program (FEM), the deformation modeling including the simulated application of at least one external force to the corneo-scleral shell, and (iv) obtaining model solutions of the FEM corresponding to predetermined boundary conditions iteratively in an incremental fashion, whereby adjustable nodal pressure is introduced inside the corneo-scleral shell, and whereby the model solutions represent IOP of the eye.

In another embodiment of the invention, the method for simulating the behavior of an eye comprises the following steps: (i) generating an asymmetric model of the eye representing the physical structure of the eye, the asymmetric model including a corneo-scleral shell having a plurality of shell elements, (ii) determining volume of the corneo-scleral shell by approximating the sum of truncated cones, wherein each of the shell elements defines a partial volume, and (iii) modeling deformations of the eye with the asymmetric model as a function of the determined volume, the deformation modeling including the simulated application of at least one external force to the corneo-scleral shell.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic illustration of the geometry of a corneo-scleral shell, according to one embodiment of the invention;

FIG. 2 is a graphical illustration of stress-strain characteristics for the sclera, cornea and a linear approximation thereof, according to one embodiment of the invention;

FIG. 3 is a graphical illustration of analytical volume as a function of pressure, according to one embodiment of the invention;

FIG. 4 is graphical illustration of analytical volume as a function of pressure, according to another embodiment of the invention;

FIG. 5 are graphical illustrations of analytical volume as a function of pressure based on four models of the invention;

FIG. 6 is a schematic illustration of an asymmetric shell element, according to one embodiment of the invention;

FIG. 7 is a schematic illustration of an iteration method for an asymmetric model, according to one embodiment of the invention;

FIG. 8 is a schematic illustration showing the generation of a wall thickness function for a finite element model, according to one embodiment of the invention;

FIG. 9 is a graphical illustration of wall thickness as a function of central angle, according to one embodiment of the invention;

FIG. 10 is a half-section computer generated plot of a corneo-scleral shell, according to one embodiment of the invention;

FIG. 11 is a graphical illustration showing discretization of a Gaussian distribution function, according to one embodiment of the invention;

FIG. 12 is a computer generated illustration of an external pressure distribution on a corneo-scleral shell, according to one embodiment of the invention;

FIG. 13 is a computer generated illustration of the boundary conditions employed for the corneo-scleral shell shown in FIG. 12, according to one embodiment of the invention;

FIG. 14 is a schematic illustration of a shell element and associated nodes forming two pyramids, according to one embodiment of the invention;

FIG. 15 is a cross-section of a finite element model, according to one embodiment of the invention;

FIG. 16 is a graphical illustration of pressure-volume characteristics for different applied forces, according to one embodiment of the invention;

FIGS. 17 and 18 are graphical illustrations of applied force vs. displacement characteristics for different IOP pressures, according to one embodiment of the invention;

FIG. 19 is a schematic illustration of an indentation apparatus that was employed during the development of the invention;

FIG. 20 is a graphical illustration of simulated force vs. displacement characteristics for six different IOP pressures, according to one embodiment of the invention; and

FIGS. 21 and 22 are further graphical illustrations of applied force vs. displacement characteristics for different IOP pressures, according to another embodiment of the invention.

### DETAILED DESCRIPTION OF THE INVENTION

Before describing the present invention in detail, it is to be understood that this invention is not limited to particularly exemplified methods, apparatus or systems, as such may, of course, vary. Thus, although a number of methods and systems similar or equivalent to those described herein can be used in the practice of the present invention, the preferred methods, apparatus and systems are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

As used in this specification and the appended claims, the singular forms “a”, “an” and “the” include plural referents unless the content clearly dictates otherwise. As such, this statement is intended to serve as antecedent basis for use of such exclusive terminology as “solely”, “only” and the like in connection with the recitation of claim elements, or use of a “negative” limitation.

Further, all publications, patents and patent applications cited herein, whether supra or infra, are hereby incorporated by reference in their entirety.

The publications discussed herein are provided solely for their disclosure prior to the filing date of the present application. Nothing herein is to be construed as an admission that the present invention is not entitled to antedate such publication(s) by virtue of prior invention. Further the dates of publication may be different from the actual publication dates, which may need to be independently confirmed.

As will be appreciated by one having ordinary skill in the art, the present invention provides models of the eye (and method for formulating same) that accurately reflect the mechanical behavior of the eye when subjected to an external force, such as during digital palpation tonometry. The invention also establishes that digital palpation tonometry applied to the scleral region of the corneo-scleral shell can be used to predict the IOP of an eye.

As will also be readily appreciated by one having skill in the art, the invention also establishes that deformation of the scleral region can be used to infer the IOP despite its greater thickness when compared the cornea. This eliminates the disadvantages and shortcomings associated with prior art of cornea-based IOP measurements.

Furthermore, it is demonstrated that static measurements of force and/or displacement are sufficient to detect changes in IOP, thus eliminating the complexity associated with dynamic mechanical measurements described in prior art.

Methods of modeling the eye will now be described in detail.

### The Eye as a Mechanical System

According to the invention, the mechanical model of the eyeball is deemed an elastic-wall sphere filled with incompressible fluid. If a force or pressure is applied on the surface, the deformation of structure modifies the shape of the fluid inside, and since the sphere has the least surface area attached to unit volume, deformation of the original shape will increase the area of the wall that causes tangential strain and tangential stress.

In order to keep the degrees of freedom of the finite element model as low as possible, as discussed in detail below, instead of using incompressible elements inside the corneo-scleral shell, an iterative method of applying adjustable nodal pressure is introduced.

### Geometry

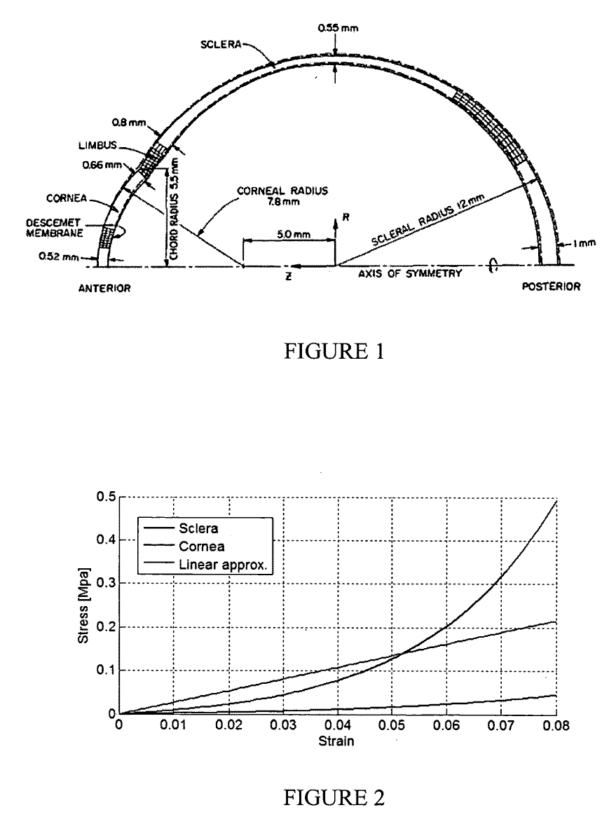

According to the invention, the elastic multilayer wall, i.e. the corneo-scleral shell, is modeled as a homogeneous elastic shell. FIG. 1 represents the dimensions that were assumed for this model. The maximum of the wall-thickness is where the photo resist nerve cells are on the optic disk, approximately where the axis of symmetry intersects the corneo-scleral shell.

As illustrated in FIG. 1, the thickness of the sclera is decreasing in the directions to the equator of the eyeball. In the finite element model (discussed below) the outer contour of the sclera is estimated with an arc of a circle and the inner contour is estimated with an elliptic arc. The sclera ends in the relatively uniform wall-thickness limbus, where it meets the cornea; the thinnest region of the corneo-scleral shell.

### Material Properties

The structural subcomponents included in the present model are the corneal stroma, limbus, sclera and Descemet's membrane. The limbus was considered to have the same mechanical properties as the cornea. The Descemet's membrane was considered to have the same mechanical properties as the sclera.

In this model an exponential approximation was used for stress strain characteristics, i.e.

σ [symbol] =A−(e^{S} [symbol] −1) (1)

where σ, MPa and c [symbol] are effective stress and effective strain.

Parameters A and B are shown in Table 1 for sclera and cornea.

TABLE 1

| | A [MPa] | B |
|---|---|---|
| Sclera | 1.80E−02 | 41.8 |
| Cornea | 5.40E−03 | 28 |

A linear approximation was also used, wherein the uniform linear elastic modulus of the corneo-scleral shell was considered to be approximately 2700 kPa. FIG. 2 represents the hyperelastic material properties for the cornea and the sclera compared to the linear model for the corneo-scleral shell.

### Analysis

In order to investigate the relationship between the inside pressure and volume, boiler formulas for a pressure loaded asymmetric membrane were employed. The formulas determine the relationship between meridian stress σₘ, tangential stress σₜ, radius of meridian curvature ρₘ, radius of tangential curvature ρₜ, inside pressure p, wall thickness t:

$$\begin{matrix}\frac{{σ}_{m}}{{ρ}_{t}} = \frac{p}{2 \cdot t} . \\ and & ( 2 ) \\ \frac{{σ}_{m}}{{ρ}_{m}} + \frac{{σ}_{t}}{{ρ}_{t}} = \frac{{ρ}_{t}}{2} . & ( 3 )\end{matrix}$$

A simple analysis can be performed by approximating the eye as a uniform wall-thickness sphere, therefore the radius of the sphere equals with the radius of meridian curvature and the radius of tangential curvature, i.e.

ρ≡ρₜ=ρₘ, (4)

and according to spherical symmetry

σ≡σₜ=σₘ, (5)

Using equations (2), (3) and (5), the following relationship is provided:

$$σ = \frac{p \cdot ρ}{2 \cdot t} \qquad ( 6 )$$

For the analysis, linear material properties were hypothesed. Hooke's law of linear elasticity describes the relationship between stress and stain state, i.e.

$$σ = \frac{E}{1 + v} ( ɛ + \frac{v}{1 - 2 v} {ɛ}_{t} I ) . \qquad ( 7 )$$

In case of plain stress:

$$\begin{matrix}σ = [ \begin{matrix}{σ}_{m} & 0 & 0 \\ 0 & {σ}_{t} & 0 \\ 0 & 0 & 0\end{matrix} ] \\ and & ( 8 ) \\ ɛ = [ \begin{matrix}{ɛ}_{m} & 0 & 0 \\ 0 & {ɛ}_{t} & 0 \\ 0 & 0 & {ɛ}_{z}\end{matrix} ] . & ( 9 )\end{matrix}$$

The scalar equation for ε_{z}:

$$0 = \frac{E}{1 + v} ( {ɛ}_{z} + \frac{v}{1 - 2 v} ( {ɛ}_{m} + {ɛ}_{t} + {ɛ}_{z} ) ) . \qquad ( 10 )$$

According to spherical symmetry,

ε≡εₜ=εₘ, (11)

and using equations (9) and (10), ε_{z} can be represented as follows:

$${ɛ}_{z} = - \frac{2 v}{1 - v} ɛ . \qquad ( 12 )$$

The meridian and tangential component of Hooke's law, considering equation (12), is represented as follows:

$$σ = \frac{E}{1 + v} ( ɛ + \frac{v}{1 - 2 v} ( 2 ɛ - \frac{2 v}{1 - v} ɛ ) ) , \qquad ( 13 )$$

and after simplification,

$$σ = \frac{E}{1 - v} ɛ . \qquad ( 14 )$$

In this case, the definition of strain is set forth below:

$$ɛ = \frac{r - {r}_{0}}{{r}_{0}} . \qquad ( 15 )$$

The stress strain relationship, using equations (6), (14) and (15), and estimating the actual radius of curvature, ρ, with the original radius of the sphere r₀, in the boiler formula:

$$\frac{{pr}_{0}}{2 {t}_{0}} = \frac{E}{1 - v} \frac{r - {r}_{0}}{{r}_{0}} . \qquad ( 16 )$$

The actual volume of the sphere is represented as follows:

$$V = \frac{4 π {r}^{3}}{3} . \qquad ( 17 )$$

Solving equations (16) and (17) for V i.e.

$$V = \frac{4 π {r}_{0}^{3}}{3} {( \frac{{pr}_{0} ( 1 - v )}{2 {t}_{0} E} + 1 )}^{3} . \qquad ( 18 )$$

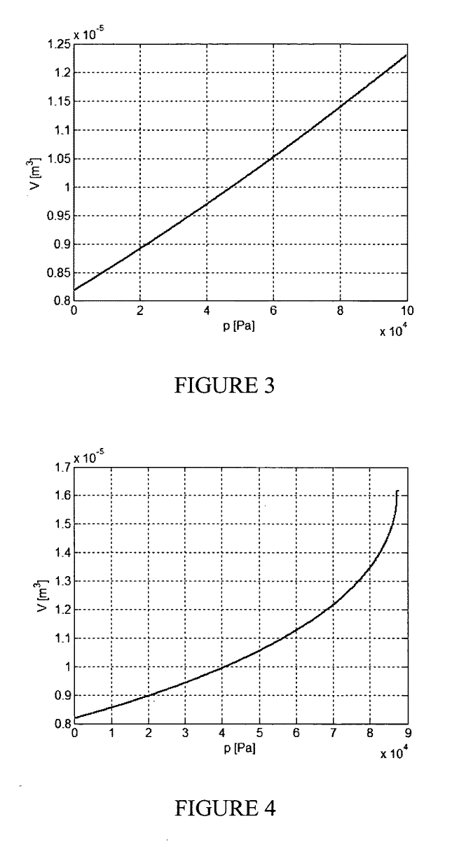

Assuming r₀=12.5 mm, t₀=0.8 mm, E=2.7 MPa and v=0.495 FIG. 3 represents the volume vs. pressure curve.

If the radius is not constant on left side of equation as well, the following equation describes the relationship between pressure and radius:

$$\frac{pr}{2 {t}_{0}} = \frac{E}{1 - v} \frac{r - {r}_{0}}{{r}_{0}} . \qquad ( 19 )$$

Solving (19) for r

$$r = \frac{2 {Er}_{0} {t}_{0}}{2 {E}_{{t}_{0}} - ( 1 - v ) {pr}_{0}} \qquad ( 20 )$$

In this case the volume vs. pressure function is represented as follows:

$$V = \frac{4 π}{3} {( \frac{2 {Er}_{0} {t}_{0}}{2 {Et}_{0} - ( 1 - v ) {pr}_{0}} )}^{3} \qquad ( 21 )$$

It should be noted that this function diverges to infinity at p_{crit}=684.3 kPa.

Instead of changing the radius in the boiler formula, the following model calculates the change in the wall thickness:

$$\begin{matrix}\frac{{pr}_{0}}{2 t} = \frac{E}{1 - v} \frac{r - {r}_{0}}{{r}_{0}} , \\ and & ( 22 ) \\ t = {t}_{0} ( {ɛ}_{z} + 1 ) , & ( 23 )\end{matrix}$$

where ε_{z} is the strain rate in the perpendicular direction to the surface of the wall:

$${ɛ}_{z} = - \frac{2 v}{1 - v} ɛ . \qquad ( 24 )$$

Solving equations (22), (23) and (17) for volume:

$$V = \frac{π}{6} {( \frac{( 1 + 3 v ) {Er}_{0} {t}_{0} - \sqrt{{E ( 1 - v )}^{2} {r}_{0}^{2} {t}_{0} ( {Et}_{0} - 4 {vpr}_{0} )}}{2 {Evt}_{0}} )}^{3} \qquad ( 25 )$$

FIG. 4 graphically illustrates the relationship between volume and pressure. The function similarly diverges to infinity; in this case at circa p_{crit}=87 kPa.

In the following analytical model, both the radius and the wall thickness is considered to change during applying inside pressure. The relationship in this instance is as follows:

$$\frac{pr}{2 t} = \frac{E}{1 - v} \frac{r - {r}_{0}}{{r}_{0}} . \qquad ( 26 )$$

Solving (23), (24), (26) and (17) for volume

$$V = \frac{π {r}_{0}^{3}}{6} ( \frac{\begin{matrix}2 E ( 1 + 3 v ) {t}_{0} - {( 1 - v )}^{2} {pr}_{0} - \\ ( 1 - v ) \sqrt{{( 1 - v )}^{2} {p}^{2} {r}_{0}^{2} - 4 E ( 1 + 3 v ) {pr}_{0} {t}_{0} + 4 {E}^{2} {t}_{0}^{2}}\end{matrix}}{4 {Evt}_{0}} ) \qquad ( 27 )$$

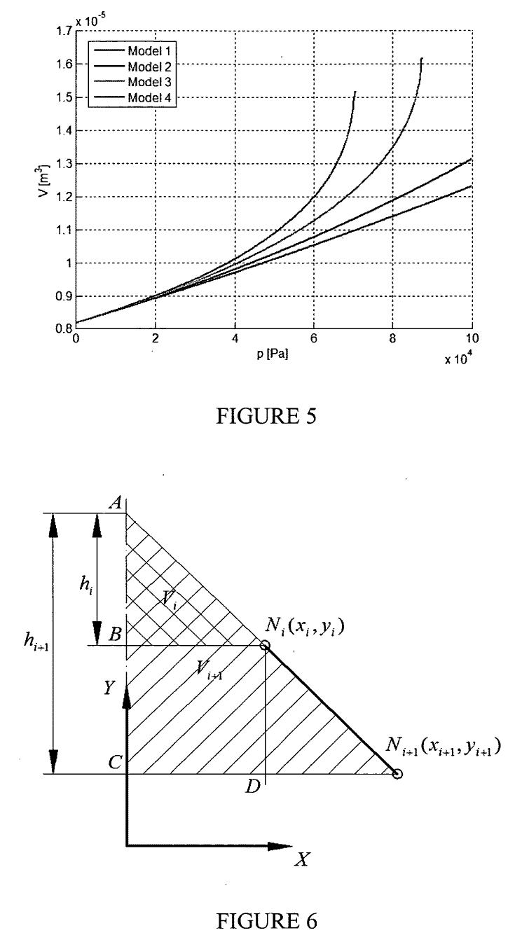

FIG. 5 represents the comparison of the four analytical models. It can be seen that at small pressure values the models reflect high coincidence.

### Asymmetric Model

For developing the alternative solution method, an asymmetric model was developed, reducing the degrees of freedom and solution time. As is well known in the art, asymmetric modeling supports asymmetric loads and boundary conditions. Since palpation acts on the sclera, and the geometrical symmetry axis intersects the cornea for the asymmetric model, a uniform wall thickness of 0.8 mm was used.

A special algorithm was developed in order to calculate the inside volume of the corneo-scleral shell. Since the model is asymmetric, during deformation phases the inside volume of the corneo-scleral shell remains asymmetric as well. Therefore, during the calculation the total volume is approximated as the sum of truncated cones, wherein each shell element defines a partial volume.

Referring to FIG. 6, there is shown an illustration of two nodes, Nᵢ and Nᵢ₊₁ representing the nodes of an element laying on the meridian curve, forming partial volumes Vᵢ and Vᵢ₊₁.

According to the similarity of triangles ABNᵢ, ACNᵢ₊₁, and Nᵢ D Nᵢ₊₁:

$$\frac{{y}_{i} - {y}_{i + 1}}{{x}_{i + 1} - {x}_{i}} = \frac{{h}_{i}}{{x}_{i}} = \frac{{h}_{i + 1}}{{x}_{i + 1}} , \qquad ( 28 )$$

therefore:

$$\begin{matrix}{h}_{i} = {x}_{i} \frac{{y}_{i} - {y}_{i + 1}}{{x}_{i + 1} - {x}_{i}} \\ and & ( 29 ) \\ {h}_{i + 1} = {x}_{i + 1} \frac{{y}_{i} - {y}_{i + 1}}{{x}_{i + 1} - {x}_{i}} . & ( 30 )\end{matrix}$$

The partial volume thus comprises a conical frustum, wherein its volume is the subtraction of the two cones, defined by the rotation of cross-sections ABNᵢ and ACNᵢ₊₁:

$$\begin{matrix}{V}_{i} = \frac{1}{3} {x}_{i}^{2} π {h}_{i} \\ and & ( 31 ) \\ {V}_{i + 1} = \frac{1}{3} {x}_{i + 1}^{2} π {h}_{i + 1} . & ( 32 )\end{matrix}$$

The volume of the conical frustum is represented by equation (33) below:

$${V}_{pi} = {V}_{i + 1} = {V}_{i} = \frac{1}{3} π ( {x}_{i + 1}^{2} {h}_{i + 1} - {x}_{i}^{2} {h}_{i} ) . \qquad ( 33 )$$

Using similarity, the following relationship is provided:

$${V}_{pi} = \frac{1}{3} π \frac{{y}_{i} - {y}_{i + 1}}{{x}_{i + 1} - {x}_{i}} ( {x}_{i + 1}^{3} - {x}_{i}^{3} ) . \qquad ( 34 )$$

In order to calculate the total volume of the asymmetric shell, the partial volumes for all the elements is summed, i.e.

$$V = \frac{1}{3} π {\sum }_{i = 1}^{N - 1} \frac{{y}_{i} - {y}_{i + 1}}{{x}_{i + 1} - {x}_{i}} ( {x}_{i + 1}^{3} - {x}_{i}^{3} ) , \qquad ( 35 )$$

where N is the number of nodes on the meridian curve.

If the cross-section of the deformed volume is concave, the value of

$$\frac{{y}_{i} - {y}_{i + 1}}{{x}_{i + 1} - {x}_{i}}$$

turns to be negative for the elements in the high-deformation region, the partial volumes attached to these elements are negative as well.

### Iteration Method

As discussed above, the mechanical model of the eyeball is deemed an incompressible fluid-filled elastic-walled pressure sphere. In order to keep the degrees of freedom low, instead of using incompressible elements in the interior of the eye, adjustable nodal pressure was applied inside corneo-scleral shell.

When the structure is loaded, the finite element solution algorithm has to increase the inside pressure until the volume of the deformed corneo-scleral shell reaches the original volume, acting like an incompressible fluid.

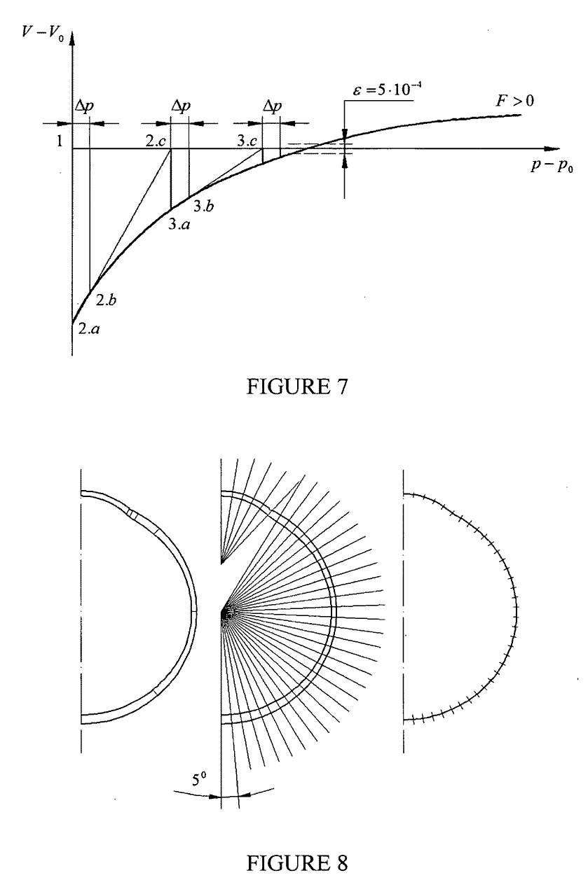

In order to calculate one point of the volume vs. pressure curve at a certain load case, volume is calculated by the method discussed above. The solution steps of the iterative algorithm that determines the increased internal pressure attached to the original volume are represented in FIG. 7, wherein p₀ represents the original intraocular pressure and V₀ represents the volume of the eyeball before external load. For initial surface pressure inside the shell, p₀ is given. In the first solution step, the structural analysis is accomplished without external load.

According to the invention, in order to determine the volume, V₀, the result of the first simulation carries out the position of the origin in solution step No. 1.

During the next solution step, p₀ is given for inside pressure and external load F is applied. After solution, the volume of the deformed corneo-scleral shell V_{2.a} is calculated. In order to determine the different quotients, an increased pressure p₀+Δp is applied. The value of Δp is arbitrary chosen. For the asymmetric model, Δp=100 Pa was applied.

After calculating volume in solution step No. 2.b, V_{2.b}, the increased inside pressure for the next solution step, is determined by the following formula:

$${p}_{2. c} - {p}_{0} = \frac{{V}_{0} - {V}_{2. a}}{{V}_{2. b} - {V}_{2. a}} Δ p \qquad ( 36 )$$

In the next solution step, the inside pressure p_{2.c} is used. After structural analysis and volume calculation the value of V_{3.a} is determined. In general, each iteration cycle requires two FEM solutions to calculate the initial pressure of the next iteration step:

$${p}_{i . c} - {p}_{( i - 1 ) . c} = \frac{{V}_{0} - {V}_{i . a}}{{V}_{i . b} - {V}_{i . a}} Δ p , \qquad ( 37 )$$

and also requires an additional FEM solution in order to determine the volume of the deformed structure applying new inside pressure, calculated by formula (37).

When the volume difference meets the convergence criterion, i.e.

$$\vert \frac{{V}_{i . a} - {V}_{0}}{{V}_{0}} \vert < ɛ , \qquad ( 38 )$$

the iteration stops. The criterion of the relative difference was chosen to be ε=5·10⁻⁴. This value is the relative accuracy of the volume calculation algorithm, which was determined by calculating the volume of an undeformed sphere and comparing it with the analytically determined value.

After the iteration is executed, the solution method carries out the correct increased pressure that increases the volume of the corneo-scleral shell to reach the original volume, i.e. the volume prior to applying the external load.

### Finite Element Model

In accordance with some embodiments of the invention, the geometry of the shell finite element model of the corneo-scleral shell is based on FIG. 1. The surface is generated by a 360-degrees rotation of the meridian curve. In order to generate the meridian curve, the centerline of the cross-section was generated.

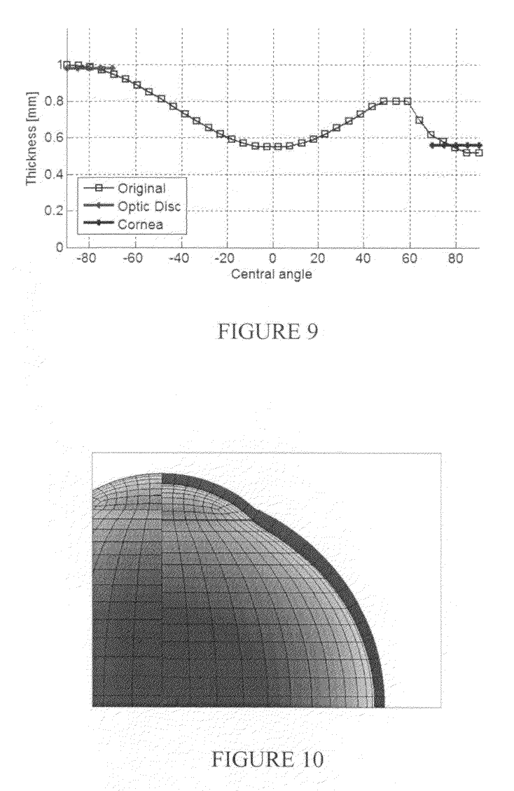

FIG. 8 represents the steps of defining the centerline and wall thickness function. In order to carry out the wall thickness function, the thickness values were assessed on every 5-degrees central angle using a CAD software. The wall thickness vs. central angle function is shown in FIG. 9.

In order to avoid highly deformed elements a constant wall thickness was applied, which is illustrated by the horizontal lines in FIG. 9.

Referring now to FIG. 10, there is shown a half section plot of the corneo-scleral shell. In this model the total external load was distributed into nodal forces. Away from the center of the indentation the values were decreasing concentrically according to the Gaussian distribution function. This approximation was used to mimic the pressure of a stiff indenter.

The general form of Gaussian distribution employed is as follows:

$$ϕ ( x ) = \frac{1}{\sqrt{2 π}} {e}^{- \frac{{( x - μ )}^{2}}{2 {σ}^{2}}} . \qquad ( 38 )$$

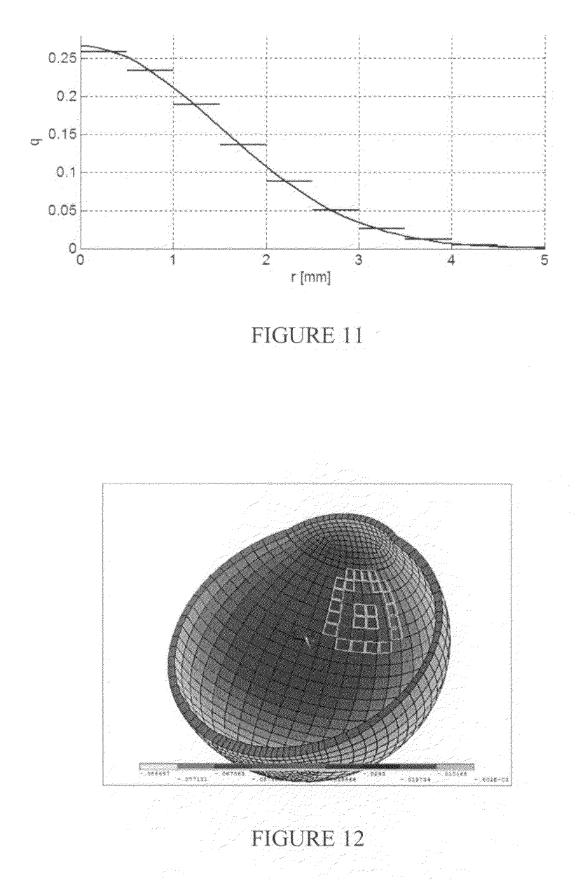

The normal distribution was created with a mean of zero and a variance of 1.5 (μ=0, σ=1.5), which is represented in FIG. 11. With these parameters, the function's value goes under 0.1% in the case of x>5; this is the estimated radius of the contact area of the stiff indenter.

The Gaussian function was discretized in the phase of 0≦x≦5, which is illustrated with the horizontal lines in FIG. 11. The ten discrete values where determined with the integrated average of the Gaussian function in each phase, and then normalized, i.e. each value was multiplied with a constant in order to reach a sum that equals with 1. The ten discrete values are represented in Table 2 below.

TABLE 2

| | qᵢ |
|---|---|
| 1 | 0.2587 |
| 2 | 0.2337 |
| 3 | 0.1887 |
| 4 | 0.1361 |
| 5 | 0.0877 |
| 6 | 0.0505 |
| 7 | 0.0260 |
| 8 | 0.0119 |
| 9 | 0.0049 |
| 10 | 0.0018 |

For the noted values the following equation is satisfied:

$${\sum }_{i = 1}^{ 10} {q}_{1} = 1. \qquad ( 38 )$$

In one embodiment, the total contact area had a radius of r=5 mm. The noted radius was divided to 10 concentrical equidistant circular areas; Aᵢ being the area of the segment i. The given total external load, F was divided into 10 partial forces, Fᵢ, using the Gaussian coefficients, qᵢ, i.e.

Fᵢ=Fqᵢ. (39)

Nodal pressure were applied on the elements attached to each segment. The particular pressure values were calculated by the following formula:

$${p}_{i} = \frac{{F}_{i}}{{A}_{i}} , \qquad ( 40 )$$

where the area of each segment, Aᵢ, was calculated by the sum of the elements belonging to the particular segment.

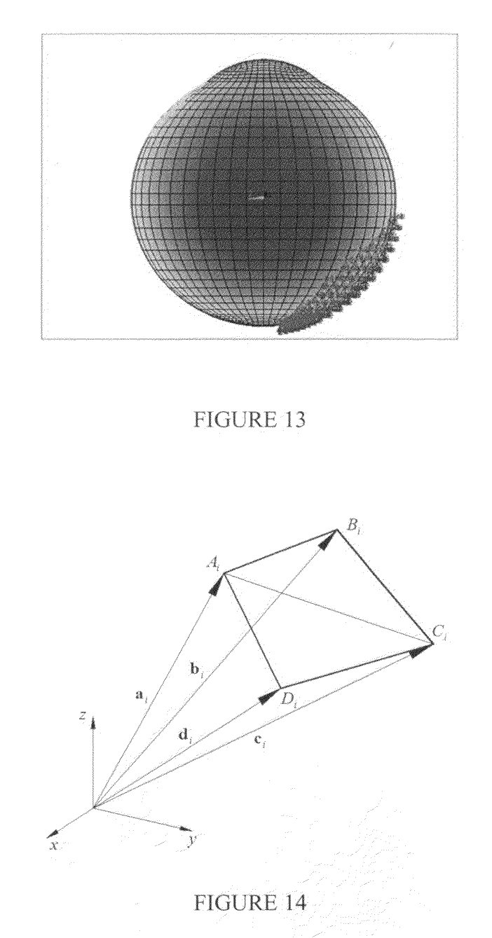

Referring now to FIG. 12, there is shown a representation of an external pressure distribution on the corneo-scleral shell. On the opposite side of the shell, a rigid support was modeled by fixing all degrees of freedom of the nodes within a 60-degrees central angle, which is represented in FIG. 13.

### Volume Calculation

In some embodiments of the invention, it is also necessary to develop a volume calculation method for this model. In this case, the inside volume of the corneo-scleral shell is estimated by a sum of triangle based pyramids. The peak of these pyramids is the origin in the center of the volume, the bases are the nodes of the shell elements. The geometry is illustrated in FIG. 14, wherein Aᵢ, Bᵢ, Cᵢ and Dᵢ represent the nodes of a shell element, and aᵢ, bᵢ, cᵢ and dᵢ are the vectors projecting from the origin to the nodes.

In order to calculate the total volume of the corneo-scleral shell, the partial volumes attached to the elements are summed. These partial volumes consisted of two triangle based pyramids.

Therefore, the total volume is as follows:

$$V = \frac{1}{6} {\sum }_{i = 1}^{n} ( < {a}_{i} , {b}_{i} , {d}_{i} > + < {c}_{i} , {d}_{i} , {b}_{i} > ) . \qquad ( 41 )$$

The values of the scalar triple products are then replaced with the determinant of following matrices:

$$V = \frac{1}{6} {\sum }_{i = 1}^{n} ( \vert \begin{matrix}{a}_{i 1} & {a}_{i 2} & {a}_{i 3} \\ {b}_{i 1} & {b}_{i 2} & {b}_{i 3} \\ {d}_{i 1} & {d}_{i 2} & {d}_{i 3}\end{matrix} \vert + \vert \begin{matrix}{c}_{i 1} & {c}_{i 2} & {c}_{i 3} \\ {d}_{i 1} & {d}_{i 2} & {d}_{i 3} \\ {b}_{i 1} & {b}_{i 2} & {b}_{i 3}\end{matrix} \vert ) . \qquad ( 42 )$$

Extracting the determinants:

$$V = \frac{1}{6} {\sum }_{i = 1}^{n} \vert \begin{matrix}\begin{matrix}{a}_{i 3} {b}_{i 2} {d}_{i 1} - {a}_{i 2} {b}_{i 3} {d}_{i 1} - \\ {a}_{i 3} {b}_{i 1} {d}_{i 2} + {a}_{i 1} {b}_{i 3} {d}_{i 2} +\end{matrix} \\ {a}_{i 2} {b}_{i 1} {d}_{i 3} - {a}_{i 1} {b}_{i 2} {d}_{i 3}\end{matrix} \vert + \frac{1}{6} {\sum }_{i = 1}^{n} \vert \begin{matrix}\begin{matrix}{b}_{i 3} {c}_{i 2} {d}_{i 1} - {b}_{i 2} {c}_{i 3} {d}_{i 1} - \\ {b}_{i 3} {c}_{i 1} {d}_{i 2} + {b}_{i 1} {c}_{i 3} {d}_{i 2} +\end{matrix} \\ {b}_{i 2} {c}_{i 1} {d}_{i 3} - {b}_{i 1} {c}_{i 2} {d}_{i 3}\end{matrix} \vert . \qquad ( 43 )$$

In equation (43) above, aᵢ₁, aᵢ₂ and aᵢ₃ are the coordinates of node, Aᵢ, bᵢ₁, bᵢ₂ and bᵢ₃ are the coordinates of node Bᵢ, cᵢ₁, cᵢ₂and cᵢ₃ are the coordinates of Cᵢ, dᵢ₁, dᵢ₂ and dᵢ₃ are the coordinates of node Dᵢ in the global coordinate system.

In the following finite element model, force vs. displacement vs. intraocular pressure characteristics were assessed by contact analysis. The indenter employed comprised a hemisphere formed by shell elements and the stiffness was chosen to be approximately three orders of magnitude larger than the stiffness of the corneo-scleral shell (E_{indenter}=3 GPa).

In this instance, instead of determining indention force, the displacement of the nodes of the indenter tool's equator was specified.

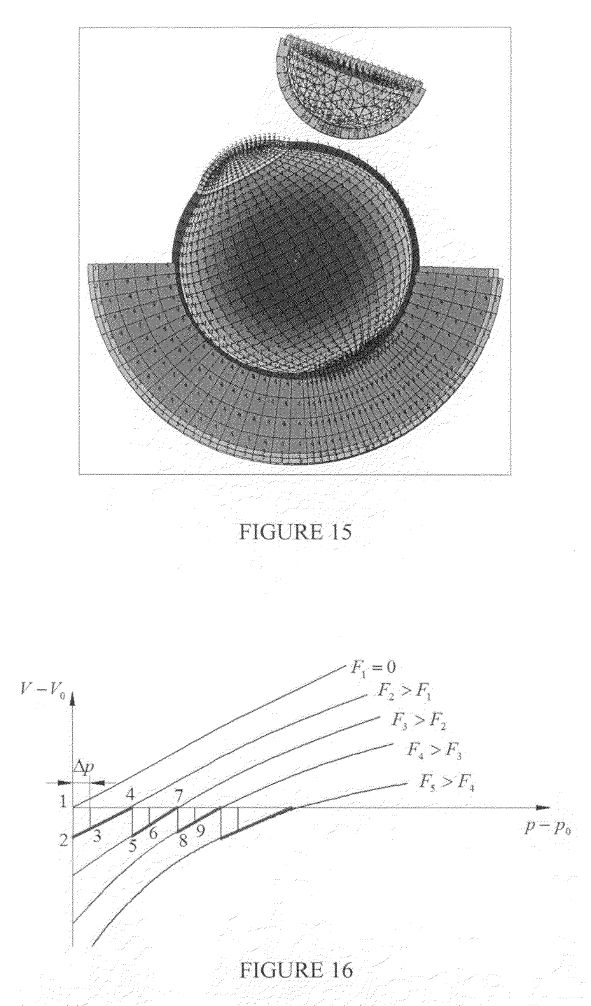

FIG. 15 illustrates the cross-section of the finite element model. An elastic support was created by extruding the shell elements under a certain plain that contains the origin. The normal vector had a 30-degrees deflection angle from the symmetry axis of the corneo-scleral shell.

The support of the extraocular muscles and organs were modeled by solid brick elements. The elements in the first layer surrounding the eyeball having common nodes with the shell elements attached to the corneo-scleral shell. In the illustrated embodiment, the total length the element extrusion was 8 mm. Four divisions were made, forming 4 layers of solid brick elements.

Since the planes of the longitudes of the corneo-scleral shell were perpendicular to the axis of symmetry of the eyeball and the axis had a deflection angle from the normal vector of the supports plane, the surface solid brick elements were staged.

The Young's modulus of the solid support was chosen to be Eₛᵤₚ=0.01 MPa. On the outer surface of the hemisphere, solid brick shell elements were generated. The stiffness of this layer was equal to the stiffness of the indenter.

### Solution Method

When the IOP of an eye is increased, its volume increases. When such eye is probed by applying external force or deformation, its internal pressure increases. Referring now to FIG. 16, point (1) illustrates the initial mechanical state of the eye when no displacement/force is applied to it. In this state, the eye has an IOP of p₀ and volume v₀. When a force F₂ is applied (or equivalently the eye is indented by a small distance u), the IOP increases and reaches point (4) (since the volume of the eyeball is considered constant).

To predict the value of IOP (point 4), according to the method described herein, a straight line is projected through points (2) and (3). The intersection of this line with the horizontal axis of the chart (V=V₀ line) is point (4). The procedure is repeated for higher values of the indentation force (points 5,6,7, . . . ).

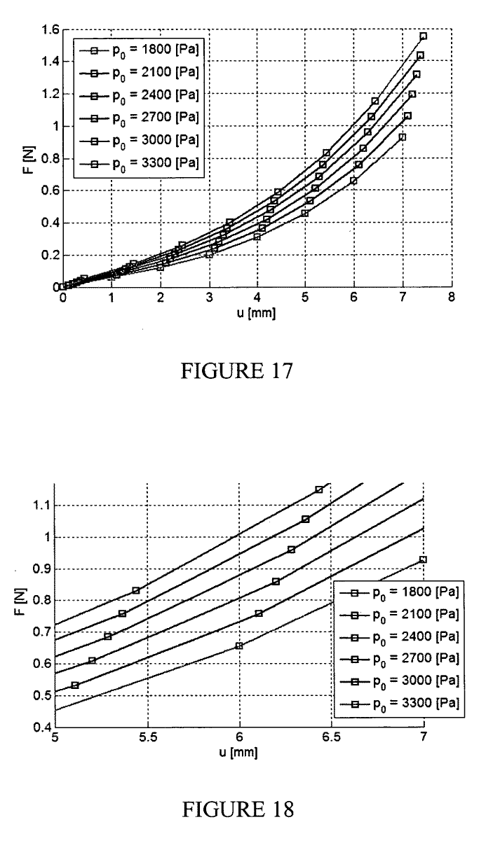

Using the above described method, it is possible to predict the evolution of IOP, as a function of the indentation of the eye by a probe. FIGS. 17 and 18 illustrate the predictions for six initial IOP values (1800, 2100, 2400, 2700, 3000, and 3300 Pa).

It should be noticed that during palpation even a few millimeters of indentation can result in appreciable change of IOP. Therefore, an accurate model of the eyeball is needed to predict the initial IOP at the start of the palpation.

### EXAMPLES

The following examples are given to enable those skilled in the art to more clearly understand and practice the present invention. They should not be considered as limiting the scope of the invention, but merely as being illustrated as representative thereof.

### Example 1

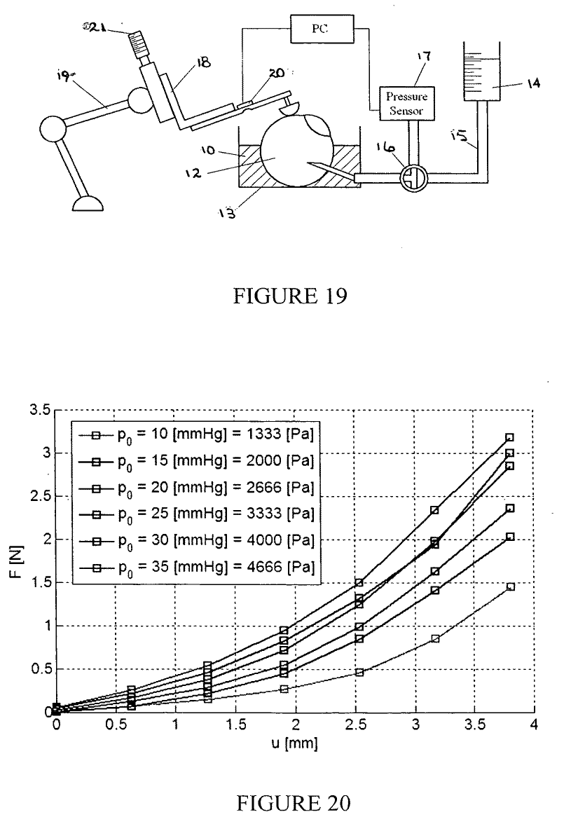

An experiment was carried out using a porcine eye and the indention apparatus shown in FIG. 19. An agarose gel solution 10 was used to anchor the eye 12 in a petri dish 13. The agarose gel solution formed a socket to hold the enucleated eye during the experiment.

The intraocular pressure was regulated by changing the height of the saline column 14, which was connected to the eye 12 with PVC tubing 15 and a syringe. A three way valve 16 was used to seal off the eye 12 during measurements. The valve 16 also facilitated connection to a pressure sensor 17.

As illustrated in FIG. 19, the indention apparatus included an L bracket 18 having a bending beam load cell and force sensor 10 attached thereto. The L bracket 18 was connected to an articulating arm 19 that facilitated positioning of the force sensor 10. Fine positioning of the apparatus was realized by a micrometer 21, which was disposed between the L bracket 18 and the end of the articulating arm 19.

After positioning the apparatus proximate the surface of the eye 12 by adjusting the articulating arm 19, force to (or penetration of) the eye 12 was realized by positioning the apparatus with the micrometer 21. For each penetration step, pressure and force values were recorded with an conventional Matlab program.

Force vs. displacement curves were measured at six different intraocular pressures, i.e. 10 mmHg, 15 mmHg, 20 mmHg, 25 mmHg, 30 mmHg, 35 mmHg, as shown in FIG. 20.

Since the ratio of average thickness of porcine cornea and human cornea is approximately 2:1, the simulations were carried out with using increased wall thickness. Also, since the porcine eyeball in the experiment touched the bottom of the petri dish, the stiffness of the elastic support was increased in order to reduce the translation of the eye. The new stiffness of the support was chosen to be ten times higher, i.e. Eₛᵤₚ=0.1 MPa.

FIG. 20 represents the comparison of force vs. displacement characteristics of the model with the original wall thickness, double wall thickness (q=2), and with the double wall thickness and increased stiffness of the support (q=2, ss.).

Each simulation was carried out with six initial intraocular pressures, the lowest pressure being pₘᵢₙ=1800 Pa , the highest being Pₘₐₓ=3300 Pa, with a pressure step increment of pᵢ₊₁−pᵢ=300 Pa.

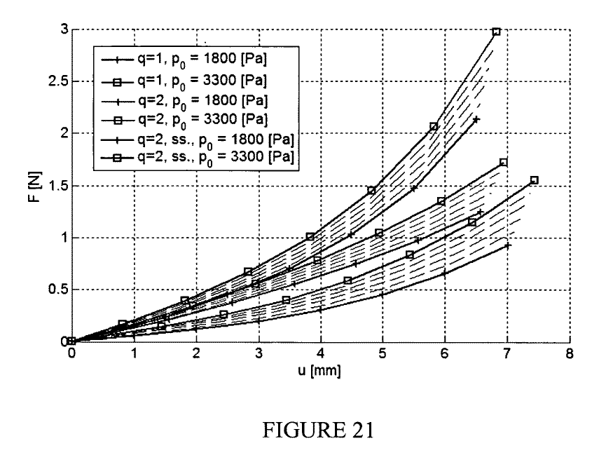

In FIG. 21, only the force vs. displacement curves reflecting the lowest and highest initial pressures are identified in the legend. The dashed lines represent the additional curves.

Several additional simulations were also made with amended material properties in order to achieve a better fit. Since these properties of the porcine corneo-scleral shell are unknown, the new stress strain characteristics were based on the previously used exponential model (see equation (1) ). The proportional term A, and the exponential term B were also modified during the probations.

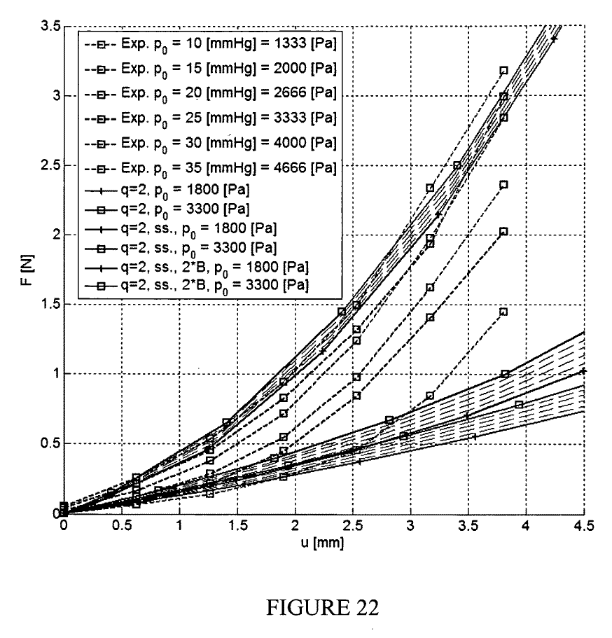

FIG. 22 represents the comparison of the experimental data force vs. displacement data, and the results of three different finite element simulations, i.e. the model with original stiffness of the support and double wall thickness (q=2), the doubled wall thickness and increased stiffness of the support (q=2, ss.), the double wall thickness, increased stiffness of the support and double B term in the material model of cornea and sclera (q=2, ss., 2*B).

It will thus be readily apparent to one having ordinary skill in the art that the invention described above provides models of the eye (and method for formulating same) that accurately reflect the mechanical behavior of the eye when subjected to an external force, such as during digital palpation tonometry. The invention also establishes that digital palpation tonometry applied to the scleral region of the comeo-scleral shell can be used to predict the IOP of an eye.

The invention further establishes that deformation of the scleral region of an eye can be used to infer the IOP, notwithstanding its greater thickness when compared the cornea, and that static measurements of force and/or displacement are sufficient to detect changes in IOP.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A method for simulating the behavior of an eye, comprising the steps of:
generating a FEM model of the eye representing the physical structure of the eye, said FEM model including an elastic walled corneo-scleral shell;
modeling deformations of the eye with said FEM model, said deformation modeling including the simulated application of at least one external force to said FEM model;
obtaining FEM model solutions iteratively in an incremental fashion, whereby adjustable nodal pressure is introduced inside said corneo-scleral shell.

2. A method for simulating the behavior of an eye, comprising the steps of:
generating a structural model of the eye, said structural model comprising an incompressible fluid-filled elastic walled corneo-scleral shell;
generating a mesh model of the eye based on said structural model, said mesh model including a plurality of nodes;
modeling deformations of the eye with a finite element program (FEM), said deformation modeling including the simulated application of at least one external force to said mesh model;
obtaining model solutions of the FEM corresponding to predetermined boundary conditions iteratively in an incremental fashion, whereby adjustable nodal pressure is introduced inside said corneo-scleral shell.

3. A method for simulating the behavior of an eye, comprising the steps of:
generating a structural model of the eye, said structural model comprising an incompressible fluid-filled elastic walled comeo-scleral shell;
generating a mesh model of the eye based on said structural model, said mesh model including a plurality of nodes;
providing stress-strain characteristics for substructures associated with the eye, said substructures including a stroma, limbus, sclera and Descemet's membrane;
determining a relationship between pressure and volume inside said corneo-scleral shell;
modeling deformations of the eye with a finite element program (FEM) as a function of said substructure stress-strain characteristics and said determined pressure and volume relationship, said deformation modeling including the simulated application of at least one external force to said mesh model;
obtaining model solutions of the FEM corresponding to predetermined boundary conditions iteratively in an incremental fashion, whereby adjustable nodal pressure is introduced inside said comeo-scleral shell.

4. A method for determining intraocular pressure (IOP) of an eye, comprising the steps of:
generating a structural model of the eye, said structural model comprising an incompressible fluid-filled elastic walled comeo-scleral shell;
generating a mesh model of the eye based on said structural model, said mesh model including a plurality of nodes;
modeling deformations of the eye with a finite element program (FEM), said deformation modeling including the simulated application of at least one external force to said corneo-scleral shell;
obtaining model solutions of the FEM corresponding to predetermined boundary conditions iteratively in an incremental fashion, whereby adjustable nodal pressure is introduced inside said corneo-scleral shell, and whereby said model solutions represent IOP of the eye.

5. A method for simulating the behavior of an eye, comprising the steps of:
generating an asymmetric model of the eye representing the physical structure of the eye, said asymmetric model including a comeo-scleral shell having a plurality of shell elements;
determining volume of said corneo-scleral shell by approximating the sum of truncated cones, wherein each of said shell elements defines a partial volume; and
modeling deformations of the eye with said asymmetric model as a function of said determined volume, said deformation modeling including the simulated application of at least one external force to said corneo-scleral shell.
